(19) United States
(12) Patent Application Publication
(10) Pub. No.: US 2024/0011384 A1
(43) Pub. Date: Jan. 11, 2024

(54) PREDICTION OF BOUND FLUID VOLUMES USING MACHINE LEARNING

(71) Applicant: Saudi Arabian Oil Company, Dhahran (SA)

(72) Inventors: Lailaa Helmi Alshammasi, Dhahran (SA); Majed Fareed Kanfar, Dhahran (SA); Yacine Meridji, Dhahran (SA); Rayan Adil Ghanim, Dhahran (SA)

(21) Appl. No.: 17/861,506

(22) Filed: Jul. 11, 2022

(51) Int. Cl. E21B 44/00; G01V 11/00

(52) U.S. Cl. CPC E21B 44/00; G01V 11/00

(57) ABSTRACT

Methods and systems, including computer programs encoded on a computer storage medium are described for implementing a system that predicts bound fluid volumes for use in well drilling operations at a subsurface region. The system derives inputs from log data generated for one or more wells. A predictive model of the system processes each of the inputs based on algorithms used to train the predictive model. Based on the processing, the model computes correlations between data points in the log data and reference parameters that are indicative of a fluid volume at the subsurface region. Based on the computed correlation, the model generates a prediction that includes a bound fluid volume for the subsurface region. The system determines a characteristic of a non-hydrocarbon fluid at a first zone of the subsurface region based on the bound fluid volume.

### TECHNICAL FIELD

This specification relates to reservoir characterization and data predictions for managing operations of wells in a subsurface region.

### BACKGROUND

Reservoir and production models can be used to monitor and manage the production of hydrocarbons from a reservoir. These models can be generated based on data sources including seismic surveys, other exploration activities, and production data. In particular, reservoir models based on data about the subterranean (or subsurface) regions can be used to support decision-making relating to field operations.

Water bearing intervals provide a significant challenge to oil production. These intervals can not only affect production, they can also affect the facilities design and could potentially hinder an entire field development plan. A typical log data acquisition program in these horizontal wells includes very basic resistivity-density-neutron-GR logs. However, due to budget constraints, magnetic resonance (MR) logs are not collected or acquired. But the lack of collection of these MR logs inhibits one's ability to identify high-risk moveable water bearing intervals. Thus, a machine-learning model that can unveil a relationship between these basic logs and certain fluid volumes is desirable, particularly where the model can capitalize on the wealth of existing data in the field.

### SUMMARY

This specification describes techniques for implementing a system that predicts magnetic resonance logs, e.g., nuclear magnetic resonance (“NMR”), for use in well drilling operations at a subsurface region. The techniques include an approach for developing and using an Artificial Intelligent (AI) based algorithm that accurately predicts NMR bound fluid volume (“BFV”) in carbonate reservoirs based on resistivity-density-neutron-GR logs in development wells. Techniques and predictive models can be used to yield optimum completion design and avoid water-bearing zones.

In particular, data items such as volumes of calcite, dolomite, and uninvaded zone water can have a significant impact on predicting NMR-BFV logs. For example, once included as inputs to a machine-learning model, these data items can significantly improve the accuracy and relevance of prediction results. The disclosed techniques leverage these concepts to provide a predictive bound fluid model that determines flowing fluid type and predicts types of producing fluids across the well based on a specific application of NMR.

One aspect of the subject matter described in this specification can be embodied in a computer-implemented method for managing operations involving a well in a subsurface region using a predictive model implemented on a hardware integrated circuit.

The method includes: deriving a plurality of inputs from log data generated for one or more wells; processing, at the predictive model, each of the plurality of inputs based on one or more algorithms used to train the predictive model; and based on the processing of the inputs, computing, at the predictive model, correlations between data points in the log data and reference parameters that are indicative of a bound fluid volume at the subsurface region.

The method includes, based on the computed correlation, generating, by the predictive model, a prediction that includes a bound fluid volume for the subsurface region; and determining, based on the bound fluid volume, a characteristic of a non-hydrocarbon fluid at a first zone of the subsurface region.

These and other implementations can each optionally include one or more of the following features. For example, in some implementations, the method further includes: controlling well drilling operations based on the prediction including the bound fluid volume and the characteristic of the non-hydrocarbon fluid. The well drilling operations are for stimulating hydrocarbon production at a reservoir of the subsurface region.

In some implementations, the method further includes: computing, using the predictive model, characterizations of the reservoir of the subsurface region and the first zone of the subsurface region based on the computed correlations and the bound fluid volume. The log data includes one or more of: gamma ray logs; density logs; resistivity logs; and neutron logs.

In some implementations, computing the correlation includes computing the correlation using: first input features derived from electrical values of the resistivity logs; second input features derived from radiation values of the gamma ray logs; and third input features derived from porosity values of the neutron logs or the density logs. In some implementations, computing the correlation includes computing the correlation based on a regression algorithm that processes the first, second, and third input features as independent variables.

In some implementations, the regression algorithm processes the reference parameters that are indicative of a fluid volume at the subsurface region as dependent variables. In some implementations, the log data: i) is generated for a plurality of development wells; and ii) includes gamma ray logs, density logs, resistivity logs, and neutron logs.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that are executable by a data processing apparatus to cause the apparatus to perform the actions.

The subject matter described in this specification can be implemented to realize one or more of the following advantages. Relative to conventional approaches, the disclosed techniques can be used to more efficiently generate accurate NMR bound fluid volumes in carbonate reservoirs. The described computational process of using machine-learning models to predict magnetic resonance logs for managing drilling operations provides an accurate, repeatable automated approach that previously could not be performed by computer systems in an efficient manner.

The disclosed model leverages data driven methodologies and integrates different types of machine-learning algorithms, including, for example, regression, deep-learning, and Random Forest models, which use specific computational processes to predict bound fluid volumes in a subsurface formation. For example, during field operations poor quality reservoir data with missing bound fluid volumes can cause inaccurate placement of hydraulic fractures and degrade well drilling operations. The machine-learning models developed based on the disclosed techniques can accurately predict missing NMR-BFVs for use in optimizing field operations and enhancing hydrocarbon production.

The disclosed techniques provide an innovative, low-risk AI-based solution for predicting NMR BFV logs, from basic resistivity-density-neutron-GR logs. The predicted logs can be integrated with petrophysical evaluations for optimum reservoir characterization. These logs can be used to obtain accurate well completion in certain hydrocarbon bearing intervals, avoid water-producing zone, circumvent costly produced water management, eliminate the need to acquire NMR logs (which can require 24-36 hours of rig time), and reduce carbon foot print. The machine-learning model can be applied to legacy wells where NMR logs were not acquired.

The details of one or more embodiments of these systems and methods are set forth in the accompanying drawings and the following description. Other features, objects, and advantages of these systems and methods will be apparent from the description and drawings, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an example process for mapping subterranean features such as facies and faults.

FIG. 2 illustrates an example computing system with a predictive machine-learning model for generating log data.

FIG. 3 shows an example process for predicting bound fluid volume using the predictive machine-learning model of FIG. 2.

FIG. 4A shows example model statistics and model accuracy for training and testing data sets.

FIG. 4B shows feature importance in predicting NMR BFV.

FIG. 5 shows an example process for predicting bound fluid volumes for reservoir characterization.

FIG. 6 is a block diagram illustrating an example computer system used to provide computational functionalities associated with described algorithms, methods, functions, processes, flows, and procedures according to some implementations of the present disclosure.

### DETAILED DESCRIPTION

Technical challenges in hydrocarbon production include the inability of conventional or standard evaluation workflows to identify if water detected at a subsurface region is movable or not at a given reservoir level. Free water bearing zones hinder hydrocarbon production and can jeopardize field development. It is often quite challenging to acquire NMR logs at least due to budget constraints and/or operational risks. This challenge provided a basis for seeking an innovative way to identify Bound Fluid Volume (BFV) from certain basic logs. Relative to conventional approaches, the innovative techniques disclosed in this document allow for optimized selection of oil bearing zones, improved completion well operations, and enhanced geo-steering of wells within a target reservoir.

In this context, techniques are described for constructing and testing predictive, machine-learning models configured to predict NMR-BFV (Bound Fluid) when measurements are either unavailable or unreliable. The disclosed techniques can be used to reduce uncertainty in well completion design and to identify free water bearing zones. The methodology disclosed in this document allows for accurate well completion and for reducing (or eliminating) undesirable water production from the well. Using data for a random sampling of wells, a model's predictions are evaluated against actual measurements to validate that the model's performance is robust and meets (or exceeds) a predefined accuracy threshold.

For example, using the disclosed techniques, a system for reservoir characterization can assess and determine an impact of various types of wireline logs as inputs to a machine-learning model to predict NMR-BFV. The system is operable to execute or run several prediction iterations using different combinations of input values to validate the model robustness against physical measurements. The system can also utilize a deployed, trained model to evaluate and/or determine economic impacts and rewards associated with potential hydrocarbon production from field operations on future development wells.

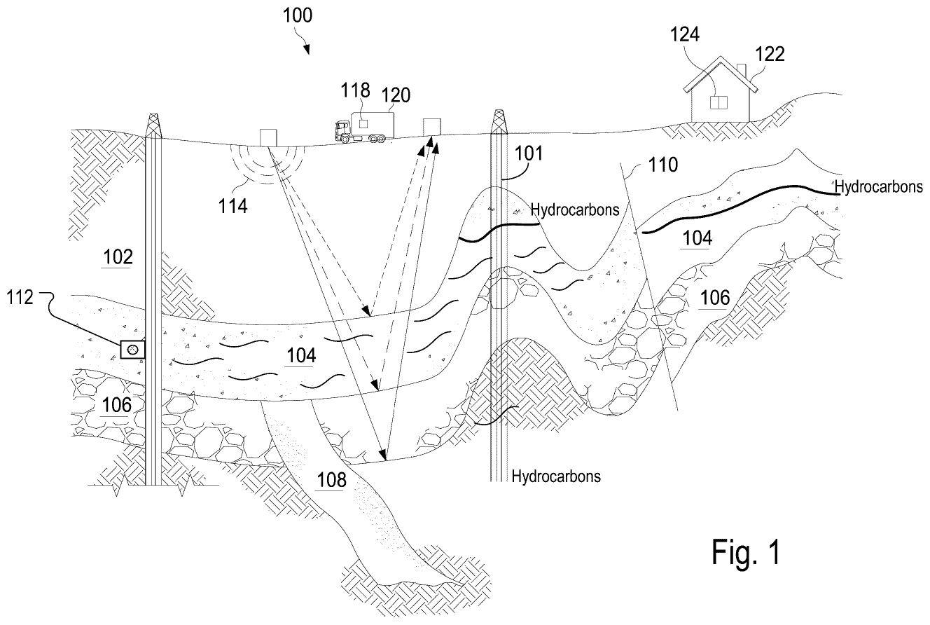

FIG. 1 is a schematic view of activities being performed to map subterranean features such as facies and faults in a subterranean formation 100. The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. The analysis and mapping of the subterranean features can be used to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A control center 122 can be operatively coupled to the control truck 120 and other data acquisition and wellsite systems. The control center 122 may have computer facilities for receiving, storing, processing, and analyzing data from the control truck 120 and other data acquisition and wellsite systems that provide additional information about the subterranean formation. For example, the control center 122 can receive data from a computer associated with a well logging unit. For example, computer systems 124 in the control center 122 can be configured to analyze, model, control, optimize, or perform management tasks of field operations associated with development and production of resources such as oil and gas from the subterranean formation 100.

Alternatively, the computer systems 124 can be located in a different location than the control center 122. Some computer systems are provided with functionality for manipulating and analyzing the data, such as performing data interpretation or borehole resistivity image log interpretation to identify geological surfaces in the subterranean formation or performing simulation, modeling, data integration, planning, and optimization of production operations of the wellsite systems.

The results of the logging and other subsurface analysis can be used to generate a geological model representing properties or characteristics of the subterranean formation 100.

The models and control systems can automatically acquire production data (e.g., gas and liquid production rates, flowing wellhead pressure (FWHP), flowing wellhead temperature). In some implementations, these models and systems can be configured to acquire measured production data in real-time, including surface measured production. For example, the production data can be acquired at a dynamic or user-defined rate, such as hourly, daily, or weekly. The data may be acquired using example logging-while-drilling (LWD) techniques performed using an example sensor 112. For example, the sensor 112 can be affixed to a portion of a drill and tuned to gather down-hole data while drilling without the requirement to remove a drill pipe or the sensor 112 from the well. The models and control systems can automatically acquire data corresponding to depth logs, gamma ray logs, and compressional sonic wireline logs.

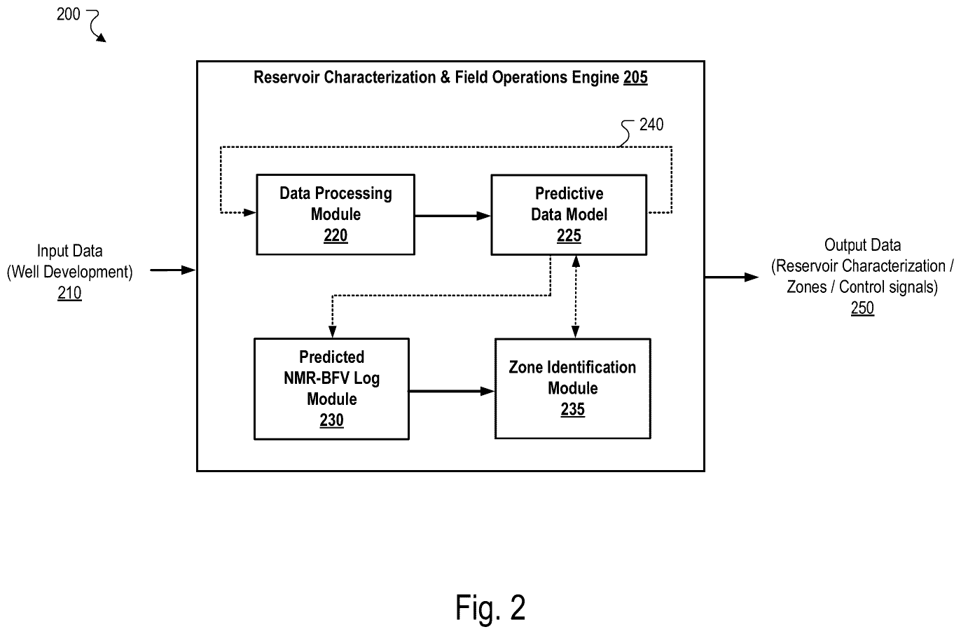

FIG. 2 illustrates an example computing system for generating log data using a predictive machine-learning model.

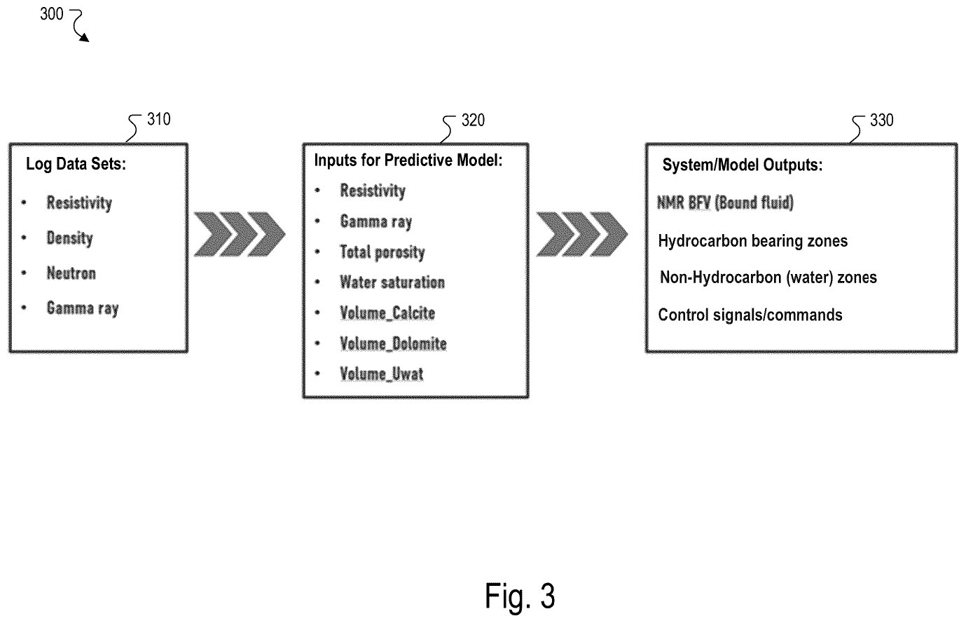

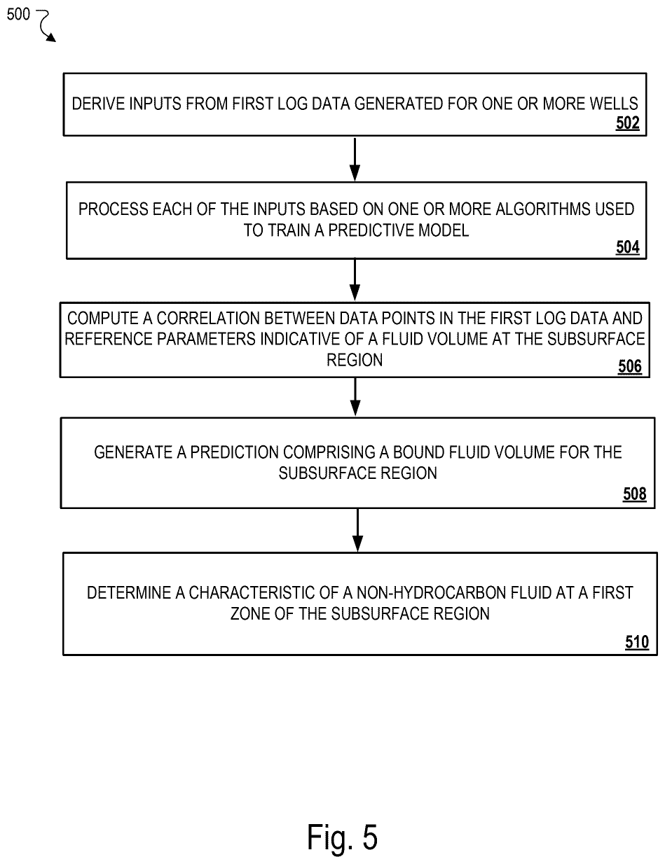

The system 200 includes a reservoir characterization and operations engine 205. The reservoir characterization engine 205 includes a data processing module 220, a machine-learning predictive data model 225 (“predictive model 225”), a predicted NMR-BFV log module 230 (“predicted log module 230”), and zone identification module 235. Each of the data processing module 220, the predictive model 225, the predicted log module 230, and the zone identification module 235 can be implemented in hardware, software, or both. The data processing module 220 and predicted log module 230 are described at least with reference to the examples of FIG. 3 and FIG. 5.

In some implementations, the term “module” includes software applications/programs or a computer that executes one or more software programs (e.g., program code) that causes a processing unit(s) of the computer to execute one or more functions. The term “computer” is intended to include any data processing device, such as a desktop computer, a laptop computer, a mainframe computer, an electronic notebook device, a computing server, a smart handheld device, or other related device able to process data.

The reservoir characterization engine 205 processes sets of input data 210 to generate output data 250. The input data 210 includes one or more wireline logs. As used in this document, wireline logs/logging involves a continuous measurement of formation properties with electrically powered instruments to infer properties and make decisions about drilling and production operations. The input data 210 can include, or be derived from, wireline logs such as gamma ray logs, neutron logs, resistivity logs, and density logs.

The input data 210 can include a training dataset, a dataset for pre-processing before being used as inputs to a machine-learning computation. In some cases, the input data 210 can include a set of candidate features or a dataset from which candidate features are derived. In some other cases, the set of candidate features are curated and refined via a feature engineering process that is executed using a data processing module 220 of the reservoir characterization engine 205. In some implementations, input data 210 includes a set of neural network inputs or feature values to be processed through layers of an example neural network implemented at a predictive model 220 of the reservoir characterization engine 205. For example, the inputs can be processed to generate an inference or predication indicating NMR-BFV values for a given subsurface formation.

The output data 250 can be based on a prediction (for example, a predicted parameter or property) that is specific to a reservoir, a subsurface region, a well or borehole, or a combination of these. For example, output data 250 can be a characterization of the reservoir or region, such as indication or location of free water bearing zones or a probability of undesirable water from a well or borehole. In some implementations, the output data 250 is an actual predication that is passed as an output of a predictive model that is accessible via the reservoir characterization and operations engine 205.

The output data 250 can include a characterization of a reservoir, a characterization of a subsurface region that includes a reservoir, a placement location for a well drilling operation, a candidate fracture location for stimulation and production of hydrocarbons, or a combination of these. In some implementations, the output data 250 is used to manage operations of a one or more wells, such as an oil or gas producing well. In some implementations, the output data 250 specifies a characteristic of a non-hydrocarbon fluid, such as water, at a first zone of the subsurface region.

The reservoir characterization engine 205 can be also utilized as an automated application for subsurface and reservoir evaluation as well as for augmenting or enhancing well operations for hydrocarbon production. For example, the reservoir characterization engine 205 can be used to predict missing or poor quality NMR-BFV data logs. In some cases, the predicted bound fluid volumes are used in geo-mechanical studies, fracture characterization, and rock physics analysis.

System 200 and the reservoir characterization engine 205 may be included in the computer system 124 described earlier with reference to FIG. 1. For example, each of system 200 and the reservoir characterization engine 205 can be included in the computer system 124 as a sub-system of hardware circuits, such as a special-purpose circuit, that includes one or more processor microchips.

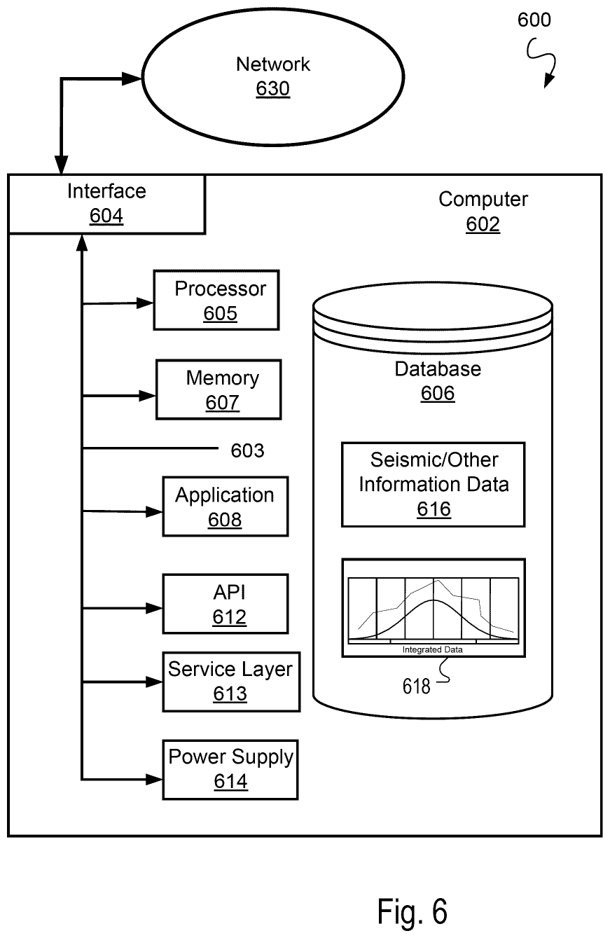

Although a single reservoir characterization engine 205 is shown in the example of FIG. 2, in some cases the computer systems 124 can include multiple reservoir characterization engines 205 as well as multiple systems 200. Each of the reservoir characterization engines 205 can include processors, for example, a central processing unit (CPU) and a graphics-processing unit (GPU), memory, and data storage devices. Each of system 200 and the reservoir characterization engine 205 can also be included in a computer system 600, which is described later with reference to FIG. 6.

The predictive model 225 can be implemented in hardware, software, or both. In some implementations, the predictive model 225 is one of multiple models that are included in a machine-learning module (“ML module”) of system 200. The ML module is used to generate one or more special-purpose predictive models for modeling properties and characteristics of a subsurface region including a well or reservoir of the region. For example, the predictive models can be used for modeling reservoir behavior in support of decision making relating to field operations for gas wells. The ML module may be an example hardware/software computing device included in the computer system 124 described earlier with reference to FIG. 1.

The ML module for implementing the predictive model 225 can be a special-purpose hardware integrated circuit of the computer systems 124, 200 and which includes one or more processor microchips. The ML module can also be included in a computer system 600, which is described later with reference to FIG. 6. The special-purpose circuitry can be used to execute machine-learning algorithms for learning or inference techniques that are implemented using, for example, neural networks, support vector machines, or dedicated hardware for regression analytics. In general, the ML module can include processors, for example, a central processing unit (CPU) and a graphics-processing unit (GPU), memory, and data storage devices that collectively form one or more computing devices of computer systems 124, 200.

The predictive model 225 has at least a training phase and an implementation phase. During the training phase, the predictive model 225 is trained in response to processing a set of training data using an example machine-learning algorithm. For example, the reservoir characterization and operations engine 205 can use at least a random forest algorithm or other related, supervised machine-learning algorithms to iteratively train the predictive model to perform its prediction, inference, and regression processes on actual production data. In some implementations, uses machine-learning algorithms and methods such as XGBoost and neural networks, including deep-learning techniques.

The training data can be a set of historic development/production data with curated values or labels relevant for generating accurate bound fluid volumes. For example, the predictive model 225 can be trained on historic wireline logs that are generated or acquired for several development wells. In some implementations, the predictive model 225 is trained until it achieves a threshold (or lowest) acceptable root-mean-square-error (RMSE). When the model achieves (or exceeds) the threshold RMSE, the predictive model 225 may then be deployed for use in analyzing and characterizing multiple wells across a given field. Deployment of the trained predictive model 225 is representative of the implementation phase of the model.

In some implementations, the trained predictive model 225 enters a validation phase where the model's performance and predicted outputs are evaluated or benchmarked against measured logs. For example, the predictive model 225 can undergo blind validation testing to ensure its prediction accuracy meets minimum accuracy threshold before the model is fully deployed or enters its implementation phase. During both a training phase and an implementation phase of the predictive model 225, the system 200 can modify the data model, for example, by adjusting the model parameters or re-tuning a set of weights of the predictive model during a subsequent training or processing iteration of the data model.

The zone identification module 235 represents an example application or program that can be used to generate reservoir characterization outputs 250 base on one or more inputs 210. In some implementations, the zone identification module 235 interacts with the predictive model 225 to obtain one or more outputs of an example data model that models certain characteristics of subsurface formations. For example, the zone identification module 235 can obtain and process outputs of an example data model to generate determinations regarding oil-bearing zones, well placement, and fracture locations.

In some implementations, the zone identification module 235 uses aspects of the predicted bound fluid volumes to compute output data 250 for managing or enhancing effectiveness of well-drilling operations. For example, the zone identification module 235 can determine hydrocarbon bearing zones for expediting timelines for well completions, initiating hydraulic fracturing, and stimulating production from oil and gas reservoirs. The zone identification module 235 can be also used to avoid water producing zones, thereby avoiding costly water management, and to indicate the presence of free water that can adversely impact hydrocarbon production.

FIG. 3 shows an example process 300 for predicting bound fluid volume using the predictive model of FIG. 2. In some implementations, process 300 corresponds to, or is representative, of operations that are described later with reference to process 500 and FIG. 500. Process 300 includes obtaining and processing one or more log data sets (310). For example, the system 200 can generate, access, or otherwise obtain log data for one or more wells or regions of a subsurface formation. The wells may be one or more development wells. The log data can include one or more of: gamma ray logs; density logs; resistivity logs; and neutron logs.

Gamma ray logging involves measuring naturally occurring gamma radiation to characterize rocks or sediment in a borehole or drill hole. Gamma ray wireline logs can measure natural radioactivity in formations and can be used for identifying lithologies and for correlating zones in a subsurface region. Density logging is another application of gamma rays in gathering data about subsurface formations and density logs can be obtained using tools that sends gamma rays into a formation and detects those that are scattered back. For example, the tools can employ techniques such as gamma-gamma scattering or photoelectric (PE) absorption.

Density logs (e.g., bulk-density wireline logs) can indicate overall bulk density as a function of the density of minerals forming a rock, i.e., a matrix, and fluids (water, oil, gas) enclosed in the pore spaces of the subsurface formation. Obtaining data for generating density logs can include use of a gamma ray source that irradiates a stream of gamma rays into the formation. The gamma rays may be absorbed, passed through the matrix, scattered, or a combination of these. The predictive model 225 can employ methods that account for, and leverage, these gamma rays characteristics when predicting NMR-BFV using at least the gamma ray wireline logs.

Neutron logging involves emitting electrically-neutral, high-energy neutrons from a source tool (e.g., a chemical source) and detecting the subsequent collision of the neutron particles with formation minerals, such as the nuclei of the formation minerals. The neutrons lose the most energy when they hit something with equal mass, such as a hydrogen atom. After being emitted the neutrons may enter a thermal state and be captured by the nuclei of other atoms. In some implementations, atoms that capture the neutron can become excited and emit a detectable gamma ray signature.

The system 200 can include detectors for detecting the thermal neutrons and the corresponding high-energy gamma rays that result from the capture. The system 200 use one or more known ratio values for detector counts to determine porosity (e.g., total porosity) of the formation, including a zone or region of the formation. In some instances, during reservoir characterization, neutrons emitted from a source/probe collide with hydrogen ions (of which water is a major source).

When this occurs the neutrons may be slowed and deflected. The detectors of system 200 can detect some (or all) of the slowed neutrons that are deflected back to toward the probe. The detectors include a counter for measuring the slowed, deflected neutrons that are detectable by the detector. Characteristics such as slowness of the detected neutrons are indicative of water content of soil or rocks in a formation, such that some neutrons are indicative of higher water content or zones of water. Thus, one or more of these logs, for example neutron or density logs, include data points (e.g., counts of deflected neutrons or bulk density) that can be used to determine or predict water bearing intervals that provide challenges or significant challenges to hydrocarbon production.

Resistivity logs can be acquired by, for example, measuring the resistance of associated rocks or sediments of a subsurface formation to the flow of electrical currents and by inducing currents into the sediments of a reservoir. In some implementations, system 200 can generate various combinations of electric and induction resistivity logs depending on the attributes of the test/development well. In some cases, reservoirs may consist of mineral grains that are highly resistive, but between them are pores saturated with fluids whose conductivity varies with composition and temperature. Thus, resistivity logs can sometimes involve the use of fluids to measure the resistance of the rocks surrounding an example borehole.

The workflow can be implemented at system 200 to derive a set of inputs for processing by the predictive model (320). The inputs can be data points such as feature values or discrete input values that are derived or extracted from distinct log data sets. For example, a first set of data points are derived from the gamma ray logs, a second set of data points are derived from the density logs, a third set of data points are derived from the resistivity logs, and a fourth set of data points are derived from the neutron logs.

In some implementations, the inputs can be feature values that are derived in response to feature engineering performed on one or more of the logs by the data processing module 220 prior to modeling. The data points/feature values can include: i) electrical values (resistance etc.) from the resistivity logs; ii) radiation values from the gamma ray logs; iii) porosity factors (e.g., total porosity) from the neutron and/or density logs; or iv) a combination of these. In some implementations, to predict an accurate NMR-BFV log the input/features values include one or more of: volume_calcite, volume dolomite (vol_dolom), Volume_uwat (uninvaded zone water volume), gamma ray (GR), resistivity, PHIT (total porosity) and SWT (water saturation).

The predictive model 225 processes the inputs features to compute one or more model outputs (330). For example, as described earlier, the predictive model 225 can process the inputs based on one or more regression algorithms or based on another machine-learning algorithm disclosed in this specification. For example, the predictive model 225 can leverage machine-learning algorithms that are constructed for applying Random Forest regression analysis techniques to data sets. In some implementations, the machine-learning algorithms allow for investigating relationships between independent variables or features and a dependent variable or outcome.

In the example of FIG. 3, the processing of the inputs by the predictive model can be used to perform a variety or system or model operations. For example, the outputs can be used to identify hydrocarbon (oil) bearing zones in a subsurface region and non-hydrocarbon bearing zones. In some implementations, the outputs are used to implement proper geo-steering of an example well within a target reservoir. For example, the outputs that are based on a predicted NMR-BFV and water-bearing zones can be used to generate control signals for controlling well drilling operations.

In some implementations, the predicted log module 230 is used compare and evaluate which ML regression approach applied by the predictive model 225 is best-suited or optimized for predicting NMR-bound fluid values. For example, the predicted log module 230 can evaluate predicted values of a first model 225 that applies a random forest approach versus a second model 225 that leverages neural networks to generate its bound fluid values. The predicted log module 230 may determine that a random forest predictive model outperforms a neural network model, or vice versa. In some implementations, the predicted log module 230 can identify or determine unique high-performance capabilities of each model and integrate the predictive responses of each model to enhance the overall accuracy of outputs 250 generated by the reservoir characterization engine 205.

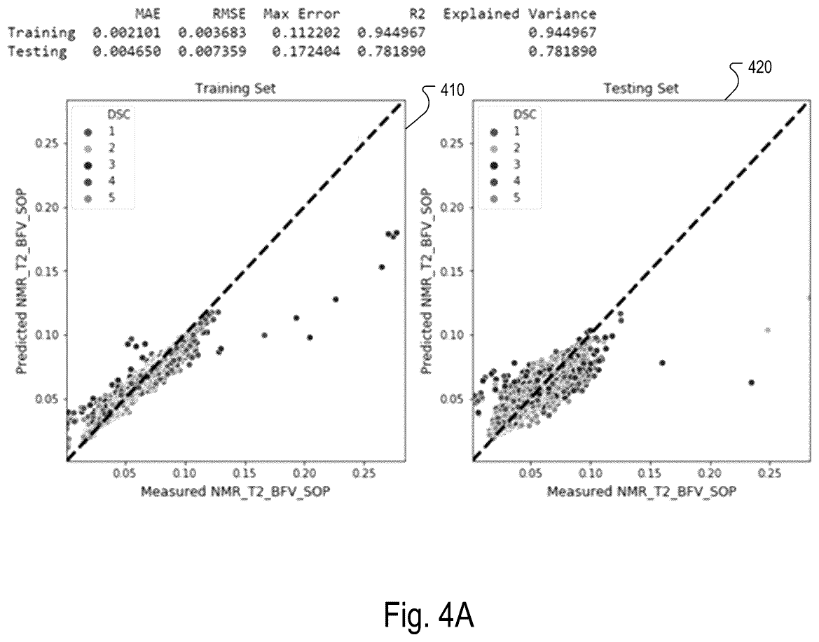

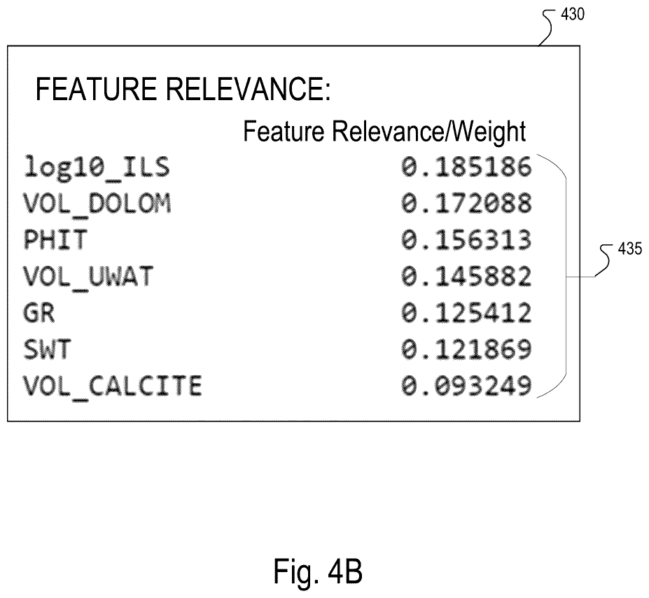

FIG. 4A shows example graphical data corresponding to datasets for training and testing an example predictive data model. The graphical data 410 corresponds to datasets for training the predictive model 225 to accurately predict NMR-BFV logs, whereas graphical data 420 corresponds to testing a datasets for testing or validating performance of the predictive model's ability to accurately predict the NMR-BFV logs. FIG. 4B shows representative features 430 that are used to train an example predictive machine-learning model. The predictive model can dynamically adjust one or more values 435 that indicate a corresponding weight or relevance of a feature with respect to accurately predicting NMR-BFV logs.

FIG. 5 shows an example process for predicting bound fluid volumes for reservoir characterization. In at least one example, the blocks of process 500 represent process steps for an automated predictive workflow that leverages different types of machine-learning algorithms to perform bound fluid log prediction. Process 500 provides a methodology that is used for predicting an NMR-BFV log.

Process 500 can be implemented or executed using the computer systems 124 and the reservoir characterization and operations engine 205 of a system 200. Hence, descriptions of process 500 may reference the computing resources of computer systems 124 and the reservoir characterization engine 205 described earlier in this document. In some implementations, the steps or actions included in process 500 are enabled by programmed firmware or software instructions, which are executable by one or more processors of the devices and resources described in this document.

Process 500 includes deriving inputs from log data that is generated for one or more wells (502). For example, the inputs may derived from a set of input data 210 that includes one or more resistivity-density-neutron-GR logs. The log data can be generated for one or more development wells as well as for other types of wells that can yield data values that are useful for generating BFV measurements and predictions.

The system 200 processes each of the inputs based on one or more algorithms used to train a predictive model (504). The system 200 processes the inputs at the reservoir characterization and operations engine 205 using the predictive model 225. As described earlier, the predictive model 225 is trained using one or more machine-learning algorithms.

The system 200 is operable to determine one or more relationships from computed correlations (506). For example, the system 200 can determine a relationship between data points in log data and reference parameters that are indicative of a fluid volume at the subsurface region. In some implementations, the system 200 determines the relationships by computing correlations between data points of distinct log data sets the form the input data 210 and the reference parameters.

For example, the system 200 can compute or otherwise determine one or more correlations between data points of a gamma ray log and a first subset of reference parameters that are descriptive of a BFV. Similarly, the system 200 can compute or otherwise determine one or more correlations between data points of a density log and the first subset of reference parameters, a second, different subset of reference parameters, or both. Each subset of reference parameters can include parameters that are required, or relevant, for determining NMR-BFV logs for a given subsurface region.

In some examples, the system 200 uses various types of machine-learning regression algorithms to train the predictive model and to compute the correlations. For example, the predictive model 225 can employ random forest algorithms, linear regression algorithms, support vector regression algorithms, decision trees, or combination of these. The predictive model 225 can employ an example XGBoost algorithm to implement gradient boosted decision trees.

For example, the predictive model 225 can use this gradient boosted framework to create a model that is trained to apply regression analysis by evaluating a tree of if-then-else true/false feature questions to predict a numeric values for bound fluid volumes (e.g., NMR-BFVs). The if-then-else true/false feature questions may be based on feature values and data points of the gamma ray, density, neutron, and/or resistivity wireline logs described earlier. For example, the feature values may be derived based on feature extraction operations performed by the data processing module 220.

In some cases, to generate predictions, the system 200 can identify and initialize different sets of independent and dependent variables for processing via one or more of the regression algorithms. For example, the system 200 can initialize (or set) one or more of the reference parameters as dependent variables, and initialize (or set) one or more of the data points of the log data as independent variables.

In some implementations, the predictive model 225 processes the inputs using special-purpose computing instructions and parameter weightings that are derived based on the one or more algorithms that are used in conjunction with the model. The system 200 can use these instructions and weightings to compute a substantial number of correlations (e.g., thousands or more) between data points across multiple sets of log data and different groupings of reference parameters that are indicative of a NMR bound fluid volumes at a given subsurface region.

The system 200 generates one or more predictions based on the computed correlation (508). In some implementations, the predictive model 225 can generate the predictions based on a regression analysis technique for investigating the relationship between different types of data points and/or parameter values. For example, the predictive model 225 may be trained to generate predictions about NMR-BFV based on relationships and correlations between independent variables of the log data (or features) and a dependent variable or outcome.

The predictions comprise a bound fluid volume for the subsurface region. The system 200 determines a characteristic of a non-hydrocarbon fluid at a first zone of the subsurface region (510). The characteristic can be determined based on the bound fluid volume as well as other output values generated by the reservoir characterization and operations engine 205.

FIG. 6 is a block diagram of an example computer system 600 used to provide computational functionalities associated with described algorithms, methods, functions, processes, flows, and procedures described in the present disclosure, according to some implementations of the present disclosure.

The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

Generally, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application-programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data, including seismic data 616 (for example, seismic data described earlier at least with reference to FIG. 1), for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus.

Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC).

In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or MS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment.

A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network.

While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

Computer readable media can also include magneto optical disks and optical memory devices and technologies including, for example, digital video disc (DVD), CD ROM, DVD±R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing.

Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A method for managing operations involving a well in a subsurface region using a predictive model implemented on a hardware integrated circuit, the method comprising:
deriving a plurality of inputs from log data generated for one or more wells;
processing, at the predictive model, each of the plurality of inputs based on one or more algorithms used to train the predictive model;
based on the processing of the inputs, computing, at the predictive model, correlations between data points in the log data and reference parameters that are indicative of a bound fluid volume at the subsurface region;
based on the computed correlation, generating, by the predictive model, a prediction comprising a bound fluid volume for the subsurface region; and
determining, based on the bound fluid volume, a characteristic of a non-hydrocarbon fluid at a first zone of the subsurface region.

2. The method of claim 1, further comprising:
controlling well drilling operations based on the prediction comprising the bound fluid volume and the characteristic of the non-hydrocarbon fluid.

3. The method of claim 2, further comprising:
computing, using the predictive model, characterizations of the reservoir of the subsurface region and the first zone of the subsurface region based on the computed correlations and the bound fluid volume.

4. The method of claim 1, wherein the log data comprises one or more of: gamma ray logs; density logs; resistivity logs; and neutron logs.

5. The method of claim 4, wherein computing the correlation comprises computing the correlation using:
first input features derived from electrical values of the resistivity logs;
second input features derived from radiation values of the gamma ray logs; and
third input features derived from porosity values of the neutron logs or the density logs.

6. The method of claim 5, wherein computing the correlation comprises computing the correlation based on a regression algorithm that processes the first, second, and third input features as independent variables.

7. The method of claim 6, wherein the regression algorithm processes the reference parameters that are indicative of a fluid volume at the subsurface region as dependent variables.

8. The method of claim 1, wherein the log data:
i) is generated for a plurality of development wells; and
ii) comprises gamma ray logs, density logs, resistivity logs, and neutron logs.

9. A system for managing operations involving a well in a subsurface region using a predictive model implemented on a hardware integrated circuit of the system,
the system comprising a processor and a non-transitory machine-readable storage device storing instructions that are executable by the processor to perform operations comprising:
deriving a plurality of inputs from log data generated for one or more wells;
processing, at the predictive model, each of the plurality of inputs based on one or more algorithms used to train the predictive model;
based on the processing of the inputs, computing, at the predictive model, correlations between data points in the log data and reference parameters that are indicative of a bound fluid volume at the subsurface region;
based on the computed correlation, generating, by the predictive model, a prediction comprising a bound fluid volume for the subsurface region; and
determining, based on the bound fluid volume, a characteristic of a non-hydrocarbon fluid at a first zone of the subsurface region.

10. The system of claim 9, wherein the operations further comprise:
controlling well drilling operations based on the prediction comprising the bound fluid volume and the characteristic of the non-hydrocarbon fluid,
wherein the well drilling operations are for stimulating hydrocarbon production at a reservoir of the subsurface region.

11. The system of claim 10, wherein the operations further comprise:
computing, using the predictive model, characterizations of the reservoir of the subsurface region and the first zone of the subsurface region based on the computed correlations and the bound fluid volume.

12. The system of claim 9, wherein the log data comprises one or more of: gamma ray logs; density logs; resistivity logs; and neutron logs.

13. The system of claim 12, wherein computing the correlation comprises computing the correlation using:
first input features derived from electrical values of the resistivity logs;
second input features derived from radiation values of the gamma ray logs; and
third input features derived from porosity values of the neutron logs or the density logs.

14. The system of claim 13, wherein computing the correlation comprises computing the correlation based on a regression algorithm that processes the first, second, and third input features as independent variables.

15. The system of claim 14, wherein the regression algorithm processes the reference parameters that are indicative of a fluid volume at the subsurface region as dependent variables.

16. The system of claim 9, wherein the log data:
i) is generated for a plurality of development wells; and
ii) comprises gamma ray logs, density logs, resistivity logs, and neutron logs.

17. A non-transitory machine-readable storage device storing instructions for managing operations at a subsurface region using a predictive model implemented on a hardware integrated circuit, the instructions being executable by a processor to perform operations comprising:
deriving a plurality of inputs from log data generated for one or more wells;
processing, at the predictive model, each of the plurality of inputs based on one or more algorithms used to train the predictive model;
based on the processing of the inputs, computing, at the predictive model, correlations between data points in the log data and reference parameters that are indicative of a bound fluid volume at the subsurface region;
based on the computed correlation, generating, by the predictive model, a prediction comprising a bound fluid volume for the subsurface region; and
determining, based on the bound fluid volume, a characteristic of a non-hydrocarbon fluid at a first zone of the subsurface region.

18. The machine-readable storage device of claim 17, wherein the operations further comprise:
controlling well drilling operations based on the prediction comprising the bound fluid volume and the characteristic of the non-hydrocarbon fluid,
wherein the well drilling operations are for stimulating hydrocarbon production at a reservoir of the subsurface region.

19. The machine-readable storage device of claim 18, wherein the operations further comprise:
computing, using the predictive model, characterizations of the reservoir of the subsurface region and the first zone of the subsurface region based on the computed correlations and the bound fluid volume.

20. The machine-readable storage device of claim 17, wherein the log data comprises one or more of: gamma ray logs; density logs; resistivity logs; and neutron logs.
